(19) United States
(12) Patent Application Publication
(10) Pub. No.: US 2025/0306972 A1
(43) Pub. Date: Oct. 2, 2025

(54) ORDERING STARTUP AND TERMINATION OF CONTAINERS

(71) Applicant: MICROSOFT TECHNOLOGY LICENSING, LLC, Redmond, WA (US)

(72) Inventor: Zhige YU, London (GB)

(21) Appl. No.: 18/622,612

(22) Filed: Mar. 29, 2024

(51) Int. Cl. G06F 9/455; H04L 67/02

(52) U.S. Cl. CPC G06F 9/45558; H04L 67/02; G06F 2009/45575

(57) ABSTRACT

A method is provided for asynchronous startup of containers within a group of containers orchestrated by an orchestrator, the method comprising receiving a request to instantiate a group of containers comprising a first container and a second container, where the second container will rely on a service run by the first container; instantiating the first container; instantiating the second container in the group, holding the second container in a waiting state, communicating the waiting state of the second container to the orchestrator;
checking periodically for a flag from the first container; setting the flag in response to the first container running the service; and transitioning the second container to a running state, in response to the flag being set, and communicating the running state to the orchestrator.

### BACKGROUND

Containers are software packages that contain application code together with their libraries and any other dependencies required for operation. Packaging the application with the dependencies allows containers to be run in a more varied number of underlying environments. Containers are distributed as an image that comprises the code and dependencies in a single file for deployment. This means that containers can be quickly instantiated to allow failure recovery and scaling up at short notice. In different orchestration platforms this is further improved by instantiating containers in logical groups to provide complimentary or interdependent applications.

There are several container platforms that manage and control the orchestration and operation of containers. One such platform is Kubernetes™ which organizes one or more containers into atomic units called pods together with a network proxy, shared storage and a kubelet that probes the containers for their activity state. This is managed by a control plane that sets up the pods from a manifest or command line, logs the states of pods and containers, and automatically provisions more pods to scale or self-heal.

Continued effort is being made to use container platforms in different technology areas. One such technology area is in telecommunications, where the quality-of-service requirements, processing demands, and uneven utilization make the scaling and self-healing provided by containers very attractive.

The embodiments described below are not limited to implementations which solve any or all the disadvantages of known container platforms.

### SUMMARY

Groups of containers, such as Kubernetes pods, are increasingly used to deploy telecommunications services including but not limited to 5G telecommunications services. Race conditions leading to dropped calls and poor performance may result where containers within a pod rely on one another. Therefore ways to control asynchronous start up or asynchronous termination are developed.

A method for asynchronous startup of containers within a group of containers orchestrated by an orchestrator is described. A request is received to instantiate a group of containers comprising a first container and a second container, where the second container will rely on a service run by the first container. The first container is instantiated. The second container in the group is instantiated and the second container is held in a waiting state. The waiting state of the second container is communicated to the orchestrator. Checks are made periodically for a flag from the first container. A flag is set in response to the first container running the service. The second container is transitioned to a running state, in response to the flag being set, and the running state is communicated to the orchestrator.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read considering the accompanying drawings, wherein:

FIG. 1 is a schematic diagram of a known system comprising a group of containers.

FIG. 2 is a schematic diagram of a system for ordering the startup and termination of containers using a shared volume.

FIG. 3 is a schematic diagram of a system for ordering the startup and termination of containers using synching servers.

FIG. 4 is a flow diagram of a method for ordering the startup of containers.

FIG. 5 is a flow diagram of a method for ordering the termination of containers.

FIG. 6 illustrates an exemplary computing-based device in which a system for ordering the startup and termination of containers is implemented in some examples.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Groups of containers, such as Kubernetes pods, are increasingly used to deploy telecommunications services including but not limited to 5G telecommunications services. Race conditions leading to dropped calls and poor performance may result where containers within a pod rely on one another. Therefore ways to control asynchronous start up or asynchronous termination are developed.

A method for asynchronous startup of containers within a group of containers orchestrated by an orchestrator is described. A request is received to instantiate a group of containers comprising a first container and a second container, where the second container will rely on a service run by the first container. The first container is instantiated. The second container in the group is instantiated and the second container is held in a waiting state. The waiting state of the second container is communicated to the orchestrator. Checks are made periodically for a flag from the first container. A flag is set in response to the first container running the service. The second container is transitioned to a running state, in response to the flag being set, and the running state is communicated to the orchestrator. By using the flag to communicate between the containers it is possible to control asynchronous startup of the containers in the group so as to avoid race conditions. Thus performance is improved and risk of dropped calls is mitigated.

A container may be in either a running state or a waiting state but not in both a running state and a waiting state at the same time. During a running state of a container an application in the container is executing with full functionality to provide a service such as, but not limited to, a telephony grade telecommunications service. During a waiting state a container is deployed on a host node of a communications network but is not able to execute with full functionality. During a waiting state a container is able to poll a file system of the host node to check for presence of a flag or to run a hyper text transfer protocol HTTP session with another container in the group. A container transitions from a waiting state to a running state in response to detecting a flag or other signal shared with another container in it's group. A container may also be in a terminated state such as when it is instructed to terminate by an orchestrator, crashes or completes its task.

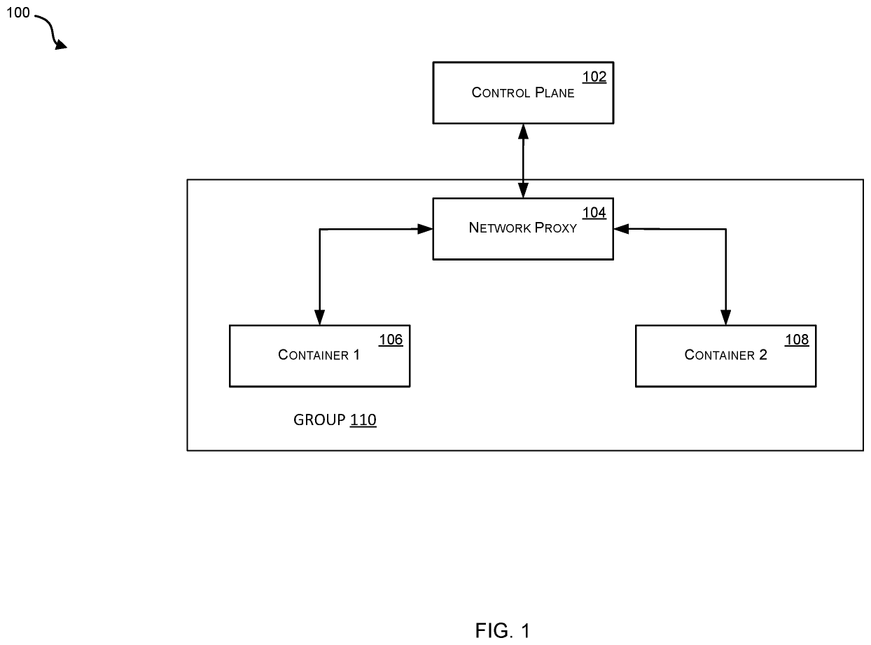

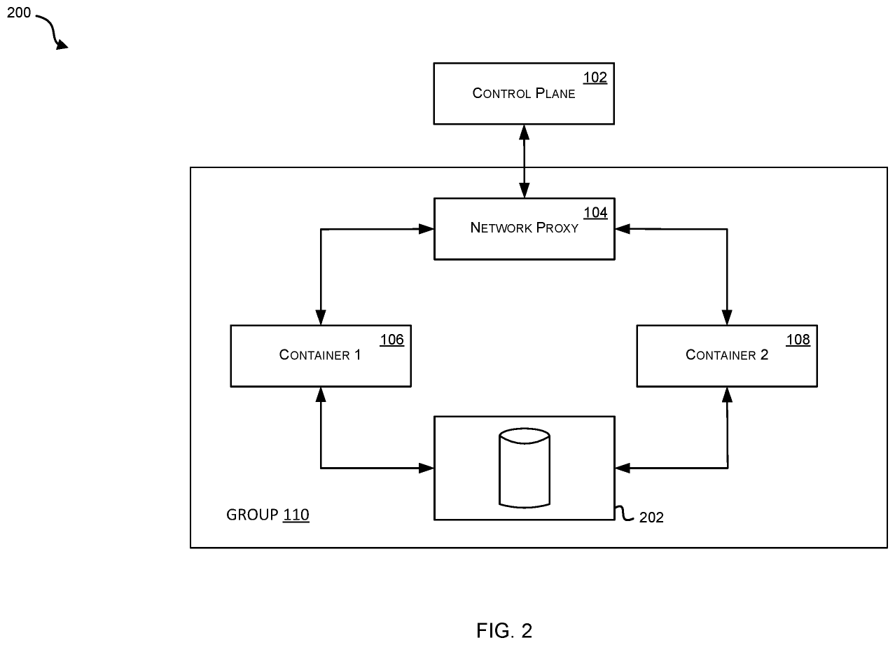

FIG. 1 is a schematic diagram of a container system 100 and aids understanding of terminology; FIG. 2 and later figures have details of control of asynchronous start up and termination. The system comprises a control plane 102, which may comprise an orchestrator, in communication with a first container 106 and a second container 108 through a network proxy 104. The network proxy may be an agent of the orchestrator. The first container 106 and the second container 108 each comprise an application to be run and the libraries on which the application depends. The first container may be for a different application than the second container. The first container 106 and the second container 108 are in a same group 110 of containers and are created at the same time. The control plane 102 creates the containers by instantiating them from a manifest stored at the control plane 102. All aspects of the system 100 can be run on virtualized or real hardware. In one example, the system 100 is a Kubernetes™ system where the first container 106, the second container 108 and the network proxy are instantiated within a same group 110 which is a Kubernetes pod.

In orchestration systems such as Kubernetes™ a group of containers is managed through a lifecycle of states such as pending, running, succeeded, and failed. A group is only scheduled once during a lifecycle and once a group is scheduled it continues to run until it is terminated. Additionally, the containers have states such as waiting, running, and terminated. In an example orchestration, the first container 106 and second container 108 in the group 110 are created in a waiting state but once a preparatory setup is complete, such as finishing loading an image or secret data from the control plane 102, they transition to a running state and begin executing immediately.

Two containers often require different times to prepare in the waiting state before transitioning to a running state where they are operational. This preparation time depends on several factors such as the size of a container image, an amount of secret data, a speed of connection to data sources in a node etc. Therefore, when starting two containers in a group 110 a chronological order in which each container transitions from waiting to running is non-determinative and difficult to predict. This causes serious issues where for example the second container 108 requires a service that will be run by the first container 106. Without direct control on the chronological order the containers will run, a race condition between the containers in the group is created. When the second container 108, that depends on services from the first container 106, runs first, errors, failures, and suboptimal performance results. A similar situation occurs at the end of the container lifecycle when a container transitions to a terminated state while another live container depends on the service it was running.

The inventors have recognized that this behavior leads to orchestration systems having disadvantages for several application areas that would otherwise benefit from containerization. These applications run two or more containers with interdependent services. One practical example being telecommunications where the first container 106 is part of a data plane for a telecommunications network and the second container 108 is part of a signaling plane for the telecommunications network. The signaling plane depends on certain functionalities offered by the data plane during its startup process. Should the signaling plane enter a running state before the data plane it would cause errors because of the lack of those key functionalities.

One solution is to use a timer for the second container 108 to delay running while the first container 106 prepares. The second container 108 is dependent on a service provided by the first container 106. However, manually setting a timer stalls the service if too much time is allocated and does not solve the problem if the time is too short. It is challenging to accurately predict how long a container will remain in the waiting phase.

FIG. 2 is a schematic diagram of a container system 200. The system 200 includes a shared volume 202. In addition to the control plane 102, network proxy 104, first container 106 and second container 108 are as in the system 100. The shared volume 202 is accessible by both the first container 106 and the second container 108. While shown with dedicated connections to both containers in other examples the shared volume 202 is accessible through a connection to the network proxy 104. In the example of a Kubernetes™ system the shared volume is a local volume, network file system or any other volume suitable to be mounted and accessed by multiple containers within the pod. Additionally, the states of the containers are communicated to the control plane from the containers through probes at the first container 106 and the second container 108 from a kubelet, or other orchestration agent (such as network proxy 104), within the pod or group 110. In an example the shared volume 202 is a file system of a host computer hosting the group.

The second container 108 initializes in a waiting state and periodically checks for a flag in the shared volume 202. Software in the application in the second container 108 causes the second container to stay in the waiting state until criteria for transitioning to a running state are met. The second container 108 does not transition out of the waiting state to a running state until it has read a flag from the shared volume 202. During this time, the second container 108 continues to communicate a waiting state to the control plane 102 through the network proxy 104. This is true even if all other conditions for the running state are fulfilled, such as the full image and secret data have been loaded successfully.

The first container comprises an application with software instructions that cause the first container to write a flag to a specified location in a the shared volume when specified conditions are met. The flag is written to the shared volume 202 by the first container 106 only after it has successfully transitioned out of the waiting state and into the running state. Therefore, the flag communicates to the second container 108 that the first container 106 is in the running state and the service that the first container 106 runs, and on which the second container 108 relies, is operational. The location of the flag within the shared volume 202 is known to both the first container 106 and the second container 108, alternatively there is a single location within the shared volume 202 which is dedicated to storing the flag. The flag is any value that is known by both the first container 106 and the second container 108 to indicate the second container 108 being in the running state. Alternatively, any non-null value being present in the shared volume 202 location is used to indicate the second container 108 being in the running state. While only two containers and one flag are described for the system 200 any number can be used.

By using the flag in the shared volume 202, to prolong the waiting state of a container and so delay the running state of the container, it is possible to set a desired chronological order for running the containers. This avoids a race state between the two containers and the errors and loss of performance from the second container 108 running while the first container 106 is still waiting. Additionally, this a resource efficient solution because accessing the shared volume does not require each container to run a server which is comparatively computationally expensive.

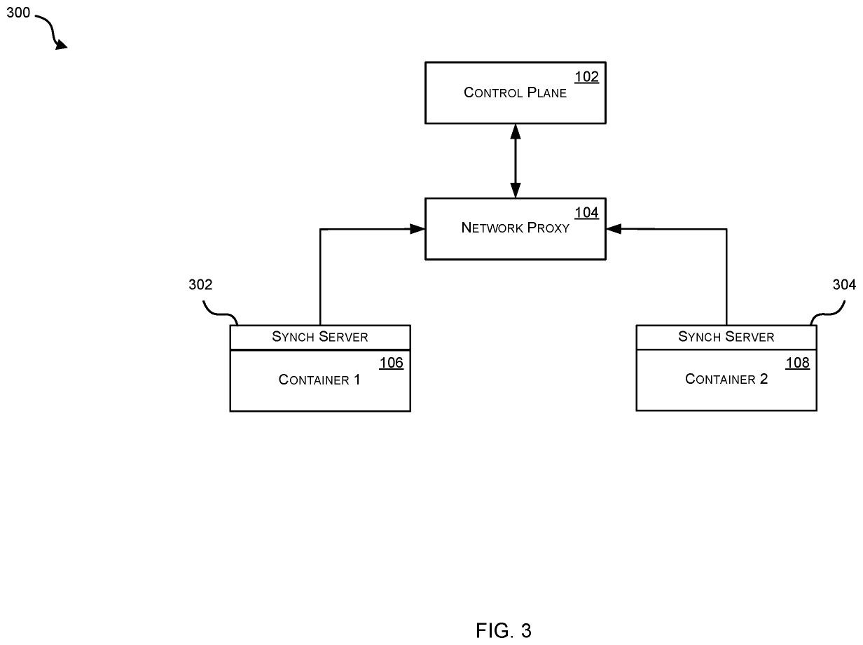

FIG. 3 is a schematic diagram of a container system 300. In addition to the control plane 102, network proxy 104, first container 106 and second container 108, the system 300 comprises a first synch server 302 and a second synch server 304 forming part of the first container 106 and the second container 108 respectively.

The first synch server 302 is a service running on the first container 106 and allows the first container 106 to send packets to and receive packets from the second container 108. The second synch server 302 is a service running on the second container 108 which allows the second container 108 to send packets to and receive packets from the first container 108. Both synch servers route packets through the network proxy 104. The synch servers are hyper text transfer protocol HTTP servers or servers running any other protocol suitable for sending packets between containers.

As with the system 200 the system 300 controls the startup of the second container 108 using a flag. However, in this example the flag is received at the second container 108 in a payload of a packet rather then retrieved from a shared volume. The second container 108 is held in a waiting state until it receives the flag packet even when all other conditions for transitioning to a running state are fulfilled. While in the waiting state, the second container 108 periodically sends query packets, using the second synch server 304, to the first container 106 querying a status of the first container 106. The query packet is interpreted by the first synch server 302 at the first container 106. If the first container 106 has successfully transitioned to a running state when the query arrives from the second container 108 then a flag packet is sent by the first container 106, using the first synch server 302. The second synch server 304 interprets the flag packet and the second container 108 transitions from the waiting state to a running state.

Query packets that arrive at the first container 106 while the first container 106 is still in a waiting state are ignored. Alternatively, a response packet is sent using the first synch server 302 communicating to the second container 108 that the first server is still in the waiting state.

With the above-described configuration, the flag packet communicates the status of the first container 106 to provide an ordered startup between the two containers with the second container 108 entering a running state after the first container 106. This avoids the race condition between the first container 106 and the second container 108 and the performance hit and crashes due to the containers starting to run in the wrong order. This provides a solution for applications where storage resources are not available or not shared between the containers.

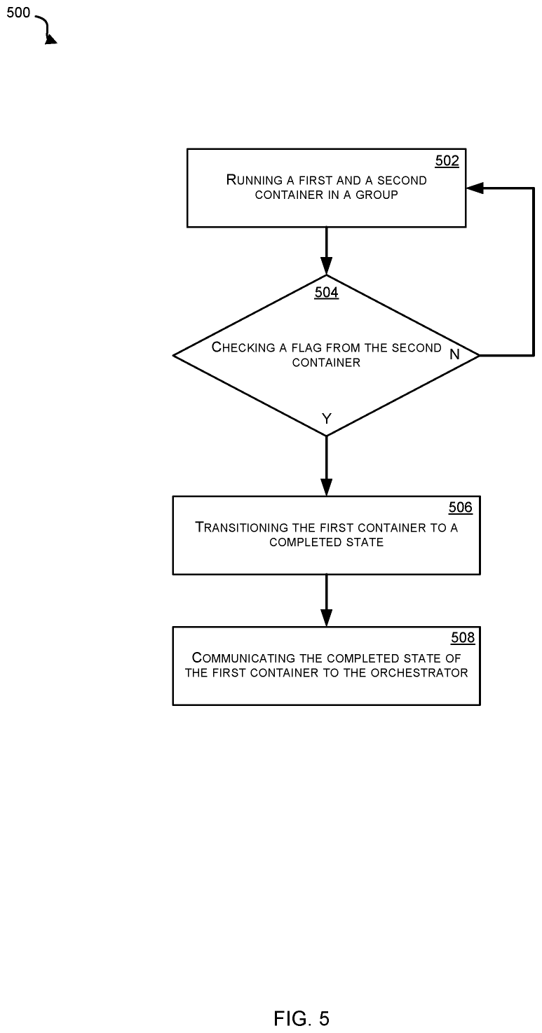

The system 200 and the system 300 can additionally be used to provide ordered termination of the containers in a group. This avoids a situation when one container terminates when another container depends upon the service it was running. More detail is provided with respect to FIG. 5 below.

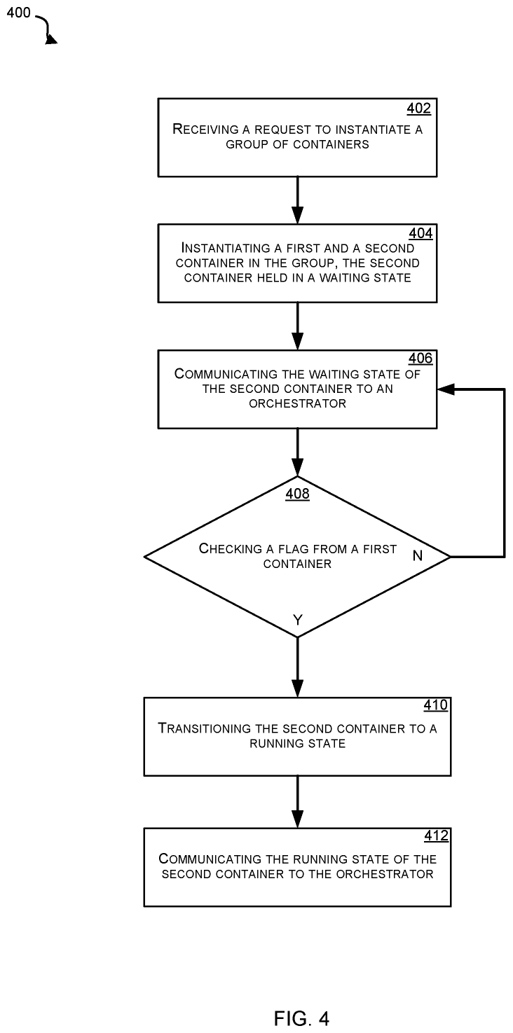

FIG. 4 illustrates a method 400 for controlling the order of running containers in a group of containers. At operation 402 a request is received from an orchestrator to instantiate a group of containers. The request may be received by the network proxy 104 which may be an agent of an orchestrator such as a Kubelet. The group comprises at least a first container and a second container such as those shown in the systems 200 and 300. Where this method is used in a Kubernetes™ system the request specifies the group of containers is a pod with more than one container. The request may be received through an application programming interface API in the form of a manifest in yet another markup language (YAML), Java script object notation JSON or any other suitable format or direct command line input.

In method step 404 the first container and the second container are instantiated by the orchestration agent, and the second container is held in a waiting state. Instantiation comprises deploying the first and second containers on a host communications network node, such as a virtual or physical machine on which they will be running. The application in the second container comprises instructions that hold it in a waiting state until specified criteria are met. During a waiting state a container is instantiated but is unable to execute full functionality of an application of the container. During instantiation, processes such as loading the container images are completed for the first container and the second container. In the Kubernetes™ system this means they are provisioned to a node and in a waiting state. The second container continues communicating a waiting state to the control plane until the criteria are met. In the Kubernetes™ system the waiting state is communicated to the control plane through probes of a kubelet within the pod comprising both the first and second containers. However, it is not essential to use a kubelet as any other orchestration agent may be used.

In operation 408 the second container checks for a flag from the first container that indicates that the first container is in the running state. In one example, the checking comprises the second container reading a shared volume location for a flag written there by the first container once it is in the running state, as described regarding the system 200.

In a second example, the checking comprises sending a query packet from the second container to the first container and receiving back any of: a flag packet indicating the first container has transitioned to the running phase, a response packet indicating the first container is still waiting, or receiving no response, as described regarding the system 300.

Where, at method step 408, the second container does not read or receive the flag indicating the first container has transitioned to the running state, the method reverts to method step 406. There the second container continues communicating the waiting state to the orchestrator via the control plane and periodically checks for the flag again.

When, at method step 408, the second container does read or receive the flag indicating the first container has transitioned to the running state, the method proceeds to method step 410 as indicated by the Y. There the second container transitions to the running state and begins performing the selected services. By waiting until the flag was present the running state of the second container is delayed until the first container is running, even if all other criteria for transitioning to the running state are fulfilled.

Having transitioned to the running state the second container communicates 412 the new state to the orchestrator via the control plane. Where the method is run in a Kubernetes system this involves a probe at the second container from a kubelet in the pod detecting the new state and communicating that to the control plane for logging. Any other orchestration agent can be used in place of the kubelet.

As described above, a lack of control of the running order for individual containers in a group of containers causes issues for applications that would otherwise benefit from containerization, such as telecommunications networks. The inventors have recognized the same is true for the termination order of the containers. For example, in the system 100 the first container 106 is running a service that other services running on the second container 108 rely upon. If the first container 106 succeeds and terminates while the second container 108 is still running there will be errors, crashes, and loss of data/performance at the second container 108.

A practical example is in telecommunications systems, where the first container 106 is running a data plane of a telecommunications network. The second container 108 is running a signaling plane of the telecommunications network. If a signal to terminate the group of containers is received and the first container 106 is terminated before the second container 108 this has to potential to drop calls, lose data or cause a system crash. This is due to the reliance of the signaling plane service running in the second container 108 on the connections provided by the data plane service running in the first container 106.

FIG. 5 illustrates a method 500 for ordering the termination of different containers in a group of containers. At method step 502 a first container and a second container in a group are in a running state. This means the services they provide are running i.e. executing. If a request to terminate the group of containers is received, or the first container reaches the completion stage of the lifecycle, the first container is held in a running state. Unlike the known systems the first container cannot move to the terminated state even if criteria to transition are met.

Instead at method step 504, the first container checks for a flag from the second container. In one example, this involves reading a shared volume for the flag. If the second container has already terminated, and it is therefore safe for the first container to terminate, then the second container will have written a flag to the shared volume as the final action before terminating. The flag is in a separate location in the shared volume to the flag used for controlling the running order of the containers or in a same location but overwritten with a different value. The value for the flag is either a specified value that both containers know to indicate the termination of the second container, or any non-null value in the designated location for the flag, as described regarding the system 200.

In a second example, the checking comprises sending a query packet from the first container to the second container and receiving back a flag packet indicating the second container has transitioned to the running phase. The checking may comprise receiving a response packet indicating the first container is still waiting or receiving no response, as described regarding the system 300.

Where, at method step 504, the first container does not read or receive the flag from the second container, the first container remains in the running state and the method 500 reverts to method step 502, as indicated by the ‘N’.

Where, at method step 504, the first container does read or receive the flag from the second container, the method progresses to method step 506 and the first container transitions to a completed or terminated state. The flag indicates to the first container that the second container has already terminated and it is therefore safe for the first container to terminate without risk of the issues described above.

At method step 508, the first container communicates the completed or terminated state to the orchestrator through the control plane. Where the orchestrator is a Kubernetes™ system, the state will be communicated from the kubelet in the pod after detecting the transition by the probe at the first container. Any other orchestration agent may be used in place of the kubelet. In one practical example, the first container is part of a data plane of a telecommunications network and can be safely terminated because the signaling plane in the second container is confirmed as having already terminated.

Enabling a container to share information about whether it is executing with another container, that relies on the container, enables a container to operate in an unconventional manner to achieve improved performance.

Using a mechanism to share information about whether a container is executing improves the functioning of an underlying communications network node by enabling control of asynchronous start up or asynchronous termination of containers in a group of containers.

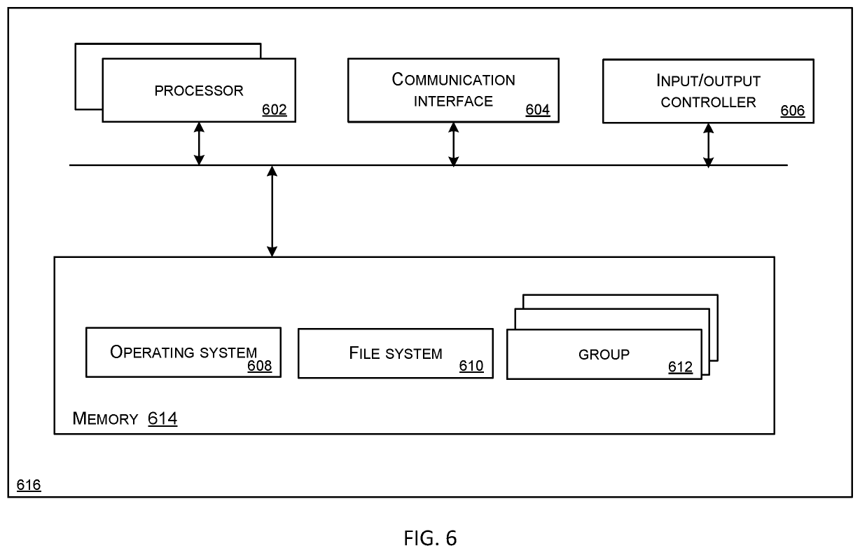

FIG. 6 illustrates various components of an exemplary computing-based device 616 which are implemented as any form of a computing and/or electronic device, and in which examples of a communications network node are implemented.

Computing-based device 616 comprises a plurality of processors 602 which are microprocessors, controllers or any other suitable type of processors for processing computer executable instructions to control the operation of the device in order to execute a telephony grade application. In an example the processors comprise a plurality of central processing units CPUs, each CPU having a plurality of processing cores. In some examples, for example where a system on a chip architecture is used, the processors 602 include one or more fixed function blocks (also referred to as accelerators) which implement a part of the method of FIG. 4 or 5 in hardware (rather than software or firmware). Platform software comprising an operating system 608 or any other suitable platform software is provided at the computing-based device. The computing-based device 616 has a plurality of groups 612 each group being a plurality of containers of a containerized telephony grade application such as a 5G telecoms service. The computing-based device 616 has a memory 614 storing a file system 610 accessible to the groups 612.

The computer executable instructions are provided using any computer-readable media that is accessible by computing based device 616. Computer-readable media includes, for example, computer storage media such as memory 614 and communications media. Computer storage media, such as memory 614, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, optical storage, magnetic storage, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 614) is shown within the computing-based device 616 it will be appreciated that the storage is, in some examples, distributed or located remotely and accessed via a network or other communication link (e.g. using communication interface 604).

The computing-based device 616 also comprises an input/output controller 606 arranged to output display information to an optional display device which may be separate from or integral to the computing-based device 616. The display information may provide a graphical user interface. The input/output controller 606 is optionally arranged to receive and process input from one or more devices, such as a user input device (e.g. a mouse, keyboard, camera, microphone or other sensor).

The computing-based device 616 is able to communicate with other nodes of a telecommunication's network via communication interface 604.

Alternatively or in addition to the other examples described herein, examples include any combination of the following clauses:

Clause A. A method for asynchronous startup of containers within a group of containers orchestrated by an orchestrator, the method comprising:
receiving a request to instantiate a group of containers comprising a first container and a second container, where the second container will rely on a service run by the first container;
   instantiating the first container;
instantiating the second container in the group and holding the second container in a waiting state,
   communicating the waiting state of the second container to the orchestrator;
checking periodically for a flag from the first container;
setting the flag in response to the first container running the service; and
transitioning the second container to a running state, in response to the flag being set and communicating the running state to the orchestrator.

Clause B. The method of clause A wherein the orchestrator is a Kubernetes orchestrator, and the group of containers is a pod of containers.

Clause C. The method of clause B wherein the waiting state and running state are communicated to a kubelet in the pod.

Clause D. The method of any preceding clause wherein the first container is part of a data plane of a telecommunications network and the second container is part of a signaling plane of the telecommunications network.

Clause E. The method of any preceding clause wherein the flag is a file stored in a shared volume accessible by the first container and the second container, and wherein checking the flag comprises reading from the file in the shared volume and setting the flag comprises writing the file to the shared volume.

Clause F. The method of any preceding clause wherein the flag is a packet sent from the first container to the second container, and wherein checking the flag comprises sending a request from the second container to the first container, and wherein setting the flag comprises sending the packet from the first container to the second container.

Clause G. The method of clause F wherein the packet is sent from a first server in the first container to a second server in the second container.

Clause H. The method of clause G wherein the first server and the second server are hypertext transport protocol (HTTP) servers.

Clause I. The method of any preceding clause wherein the first container and the second container are instantiated on one of bare metal and a virtual machine. Bare metal refers to a physical computing node such as a server.

Clause J. A method for asynchronous termination of containers within a group of containers orchestrated by an orchestrator, the method comprising: running a first container and a second container in the group of containers, where the second container relies on a service being run by the first container; checking periodically for a flag from the second container in the group of containers; transitioning a first container from a running state to a completed state, in response to the flag being set; and communicating the completed state of the first container to the orchestrator.

Clause K. The method of clause J wherein the flag is set, in response to the second container entering a completed state.

Clause L. The method of clause J or clause K wherein the orchestrator is a Kubernetes orchestrator, and the group of containers is a pod of containers.

Clause M. The method of clause K wherein completed state is communicated to a kubelet in the pod.

Clause N. The method of any of clauses J to M wherein the first container is part of a data plane of a 5G telecommunications network, and the second container is part of a signaling plane of the 5G telecommunications network.

Clause O. The method of clause N wherein the first container and the second container form a session border controller (SBC) in the telecommunications network.

Clause P. The method of clause O wherein the second container enters a completed state when all calls registered to the SBC are finished.

Clause Q. The method of any of clauses J to P wherein the flag is a file stored in a shared volume accessible by the first container and the second container, and wherein checking the flag comprises reading from the file in the shared volume and setting the flag comprises writing the file to the shared volume.

Clause R. The method of any of clauses J to Q wherein the flag is a packet, and wherein checking the flag comprises sending a request from the first container to the second container, and wherein setting the flag comprises sending the packet from the second container to the first container.

Clause S. The method of any of clauses J to R wherein the first container and the second container are instantiated on one of bare metal and a virtual machine.

Clause T. A communications network node comprising:
a processor; and
a memory storing instructions which, when executed by the processor, cause the processor to
   receive a request to instantiate a group of containers comprising a first container and a second container, where the second container will rely on a service run by the first container;
   instantiate the first container;
instantiate the second container in the group and hold the second container in a waiting state,
   communicate the waiting state of the second container to the orchestrator;
check periodically for a flag from the first container;
set the flag in response to the first container running the service; and
transition the second container to a running state, in response to the flag being set and communicating the running state to the orchestrator.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various examples have been described above with a certain degree of particularity, or with reference to one or more individual embodiments, those skilled in the art could make numerous alterations to the disclosed embodiments without departing from the scope of this specification.

What is claimed is:

1. A method for asynchronous startup of containers within a group of containers orchestrated by an orchestrator, the method comprising:
receiving a request to instantiate a group of containers comprising a first container and a second container, where the second container will rely on a service run by the first container;
instantiating the first container;
instantiating the second container in the group and holding the second container in a waiting state,
communicating the waiting state of the second container to the orchestrator;
checking periodically for a flag from the first container;
setting the flag in response to the first container running the service; and
in response to the flag being set, transitioning the second container to a running state; and
communicating the running state to the orchestrator.

2. The method of claim 1, wherein the orchestrator is a Kubernetes orchestrator, and the group of containers is a pod of containers.

3. The method of claim 2, wherein the waiting state and running state are communicated to a kubelet in the pod.

4. The method of claim 1, wherein the first container is part of a data plane of a telecommunications network and the second container is part of a signaling plane of the telecommunications network.

5. The method of claim 1, wherein the flag is a file stored in a shared volume accessible by the first container and the second container, and wherein checking the flag comprises reading from the file in the shared volume and setting the flag comprises writing the file to the shared volume.

6. The method of claim 1, wherein the flag is a packet sent from the first container to the second container, and wherein checking the flag comprises sending a request from the second container to the first container, and wherein setting the flag comprises sending the packet from the first container to the second container.

7. The method of claim 6, wherein the packet is sent from a first server in the first container to a second server in the second container.

8. The method of claim 7, wherein the first server and the second server are hypertext transport protocol (HTTP) servers.

9. The method of claim 1, wherein the first container and the second container are instantiated on one of bare metal and a virtual machine.

10. A method for asynchronous termination of containers within a group of containers orchestrated by an orchestrator, the method comprising:
running a first container and a second container in the group of containers, where the second container relies on a service being run by the first container;
checking periodically for a flag from the second container in the group of containers;
transitioning a first container from a running state to a completed state, in response to the flag being set; and
communicating the completed state of the first container to the orchestrator.

11. The method of claim 10, wherein the flag is set, in response to the second container entering a completed state.

12. The method of claim 10, wherein the orchestrator is a Kubernetes orchestrator, and the group of containers is a pod of containers.

13. The method of claim 12, wherein completed state is communicated to a kubelet in the pod.

14. The method of claim 10, wherein the first container is part of a data plane of a 5G telecommunications network, and the second container is part of a signaling plane of the 5G telecommunications network.

15. The method of claim 14, wherein the first container and the second container form a session border controller (SBC) in the telecommunications network.

16. The method of claim 15, wherein the second container enters a completed state when all calls registered to the SBC are finished.

17. The method of claim 10, wherein the flag is a file stored in a shared volume accessible by the first container and the second container, and wherein checking the flag comprises reading from the file in the shared volume and setting the flag comprises writing the file to the shared volume.

18. The method of claim 10, wherein the flag is a packet, and wherein checking the flag comprises sending a request from the first container to the second container, and wherein setting the flag comprises sending the packet from the second container to the first container.

19. The method of claim 10, wherein the first container and the second container are instantiated on one of bare metal and a virtual machine.

20. A communications network node comprising:
a processor; and
a memory storing instructions which, when executed by the processor, cause the communications network node to perform operations comprising:
receive a request to instantiate a group of containers comprising a first container and a second container, where the second container will rely on a service run by the first container, the group of containers orchestrated by an orchestrator;
instantiate the first container;
instantiate the second container in the group and hold the second container in a waiting state,
communicate the waiting state of the second container to the orchestrator;
check periodically for a flag from the first container;
set the flag in response to the first container running the service; and
transition the second container to a running state, in response to the flag being set; and
communicating the running state to the orchestrator.
